(19) United States
(12) Patent Application Publication
(10) Pub. No.: US 2020/0122714 A1
(43) Pub. Date: Apr. 23, 2020

(54) MACHINES, SYSTEMS AND METHODS FOR AUTOMATED POWER MANAGEMENT

(71) Applicant: Nilfisk A/S, Brondby (DK)

(72) Inventors: Hanafi Habbas, Blaine, MN (US); Ganesh Borra, Plymouth, MN (US); Chris Parker, Plymouth, MN (US)

(21) Appl. No.: 16/719,659

(22) Filed: Dec. 18, 2019

Related U.S. Application Data
(63) Continuation-in-part of application No. 15/628,283, filed on Jun. 20, 2017.
Application No. 15/628,283 is a continuation-in-part of application No. 15/628,295, filed on Jun. 20, 2017.

(51) Int. Cl. B60W 20/40; A47L 11/283

(52) U.S. Cl. CPC B60W 20/40; B60W 2710/244; B60W 2710/0644; A47L 11/283

(57) ABSTRACT

Example control systems for automated power management of a motive machine. The features are described with reference to a hybrid powered sweeper-scrubber machine, but is not limited as such. The machine can include a main machine controller (MMC) operably coupled to an engine, and a power module operably coupled to the MMC by a controller area network (CAN) bus. A sub-system, including a sub-system having one or more electrical components such as motors, can be operably coupled to the power module by the CAN bus. To provide automated power control, the power module can monitor a load of the sub-system, and using the monitored load of the sub-system, the power module can communicate sub-system load information to the MMC. The MMC can automatically adjust an engine speed based on the monitored sub-system load information and the selected functional mode of the machine.

### CROSS-REFERENCE TO RELATED APPLICATIONS

This application is a continuation-in-part of and claims the benefit of priority under 35 U.S.C. § 120 to U.S. patent application Ser. No. 15/628,283, filed on Jun. 20, 2017, and is a continuation-in-part of and claims the benefit of priority under 35 U.S.C. § 120 to U.S. patent application Ser. No. 15/628,295, filed on Jun. 20, 2017, each of which is incorporated by reference herein in its entirety.

### TECHNICAL FIELD

This document pertains generally, but not by way of limitation, to controlling a machine, such as a motive machine that can be a hybrid machine having both fuel-powered and battery-powered modes. More specifically, the disclosure can be applied to an industrial floor cleaning machine, such as a hybrid sweeper-scrubber machine. However, aspects of the disclosure can be applied to machines other than hybrid machines and machines other than industrial floor cleaning machines.

### BACKGROUND

Hybrid machines that use both fuel-powered modes (e.g., gas engines) and battery-powered modes have been introduced to replace machines that previously were solely fuel-powered machines. Control modules can be used to control the function of the machine and to switch between the fuel-powered and electric powered modes. One area where hybrid machines have been introduced is in floor cleaning machines.

Industrial and commercial floors can be cleaned on a regular basis for aesthetic and sanitary purposes. There are many types of industrial and commercial floors ranging from hard surfaces, such as concrete, terrazzo, wood, and the like, which can be found in factories, schools, hospitals, and the like, to softer surfaces, such as carpeted floors found in restaurants and offices. Different types of floor cleaning equipment, such as scrubbers, sweepers, and extractors, have been developed to properly clean and maintain these different floor surfaces.

A typical scrubber is a walk-behind or drivable, self-propelled, wet process machine that applies a liquid cleaning solution from an onboard cleaning solution tank onto the floor through nozzles fixed to a forward portion of the scrubber. Rotating brushes forming part of the scrubber rearward of the nozzles agitate the solution to loosen dirt and grime adhering to the floor. The dirt and grime become suspended in the solution, which is collected by a vacuum squeegee fixed to a rearward portion of the scrubber and deposited into an onboard recovery tank.

Scrubbers are very effective for cleaning hard surfaces. Unfortunately, debris on the floor can clog the vacuum squeegee, and thus, the floor should be swept prior to using the scrubber. Thus, sweepers are commonly used to sweep a floor prior to using a scrubber. A typical sweeper is a self-propelled, walk-behind, or drivable dry process machine which picks debris off a hard or soft floor surface without the use of liquids. The typical sweeper has rotating brushes which sweep debris into a hopper or “catch bin.”

Combination sweeper-scrubber machines have been developed that provide the sweeping and scrubbing functionality in a single unit and are available in both fuel powered and battery powered designs. More recently, “hybrid” type sweeper-scrubber machines that are capable of operating in fuel or battery powered modes have also been developed.

### BRIEF DESCRIPTION OF THE DRAWINGS

In the drawings, which are not necessarily drawn to scale, like numerals can describe similar components in different views. Like numerals having different letter suffixes can represent different instances of similar components. The drawings illustrate generally, by way of example, but not by way of limitation, various examples discussed in the present document.

FIG. 1 is a top perspective view of an illustrative hybrid sweeper-scrubber machine that can utilize a scrub deck retraction apparatus, in accordance with at least one example.

FIG. 2 is a bottom perspective view of the hybrid sweeper-scrubber machine of FIG. 1, in accordance with at least one example.

FIG. 3 is an internal perspective of the hybrid sweeper-scrubber machine of FIG. 1, in accordance with at least one example.

FIG. 4 is a flow chart illustrating an illustrative control method that can be used with a machine such as, but not limited to, the hybrid sweeper-scrubber of FIG. 1, in accordance with at least one example.

FIG. 5 is a functional diagram of an illustrative control system that can be used with a machine such as, but not limited to, the hybrid sweeper-scrubber of FIG. 1, in accordance with at least one example.

FIGS. 6A and 6B are functional diagrams of aspects of a control system including power modules that can be used with a machine such as, but not limited to, the hybrid sweeper-scrubber of FIG. 1, in accordance with at least one example.

FIG. 7 is a functional diagram of an illustrative (controller area network) CAN bus,

FIG. 8 is an illustrative method for controlling a motive machine, in accordance with at least one example.

FIG. 9 is an illustrative method for controlling an output of a scrub motor, in accordance with at least one example.

FIG. 10 is a general diagram of a motor and scrub element that can be lifted by an actuator, in accordance with at least one example.

FIG. 11 is an illustrative method of using a power module to monitor and control an output of a motor by pulse width modulation, in accordance with at least one example.

FIG. 12 is an illustrative schematic of a fail-safe feature for a power module including a solenoid.

FIG. 13 shows an example: schematic of the solenoid 1300 that may be used in the example power module of FIG. 12.

### DETAILED DESCRIPTION

The present disclosure relates generally to machines, such as motive machines that have a movable or transport aspect. In some examples, the machine can be a hybrid machine that can be operated in a fuel-powered or battery-powered mode. However, this disclosure includes features that can be applied to machines that do not necessarily have a hybrid power system (e.g., fuel only or electric only).

In some examples, the machine can include a cleaning apparatus such as a sweeper-scrubber machine. For the purposes of illustration, a hybrid sweeper-scrubber machine is described herein. Again, the disclosure can be applied to other types of machines, including other types of vehicles and machines that do not have a cleaning aspect.

Conventional machines such as motive machines can have challenges including how to manage power control and distribution. One challenge is that in order for a machine to control power across all electrical components in the machine, many individual current sensors need to be provided for each electrical component, and each electrical component provides feedback to the main controller (MMC). This disclosure includes aspects related to engine speed control to compensate for additional loads being placed on components of the machine and to prevent overloading of various motors of the machine.

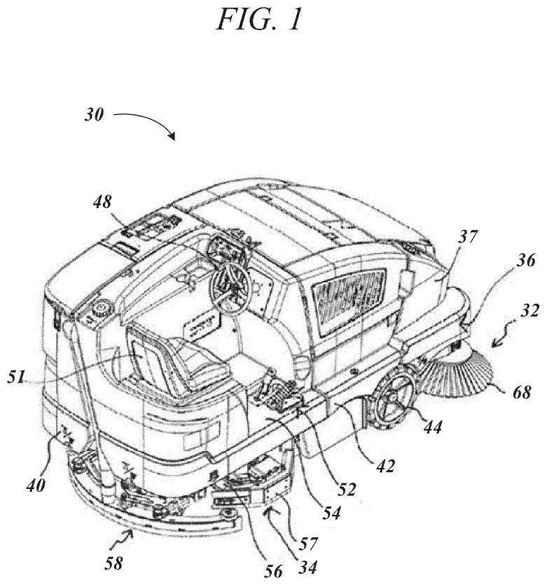

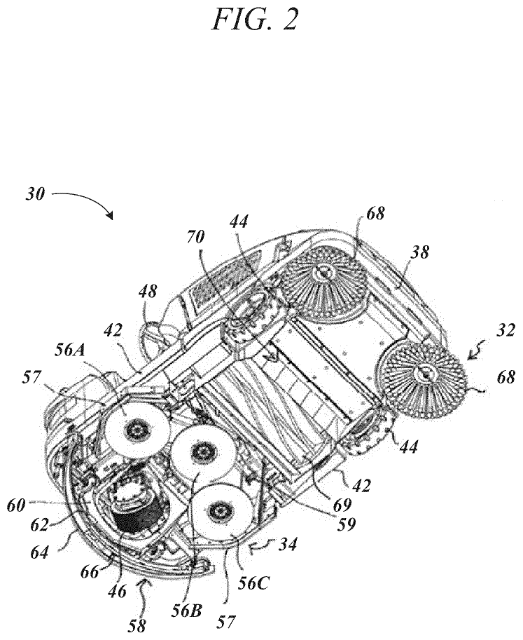

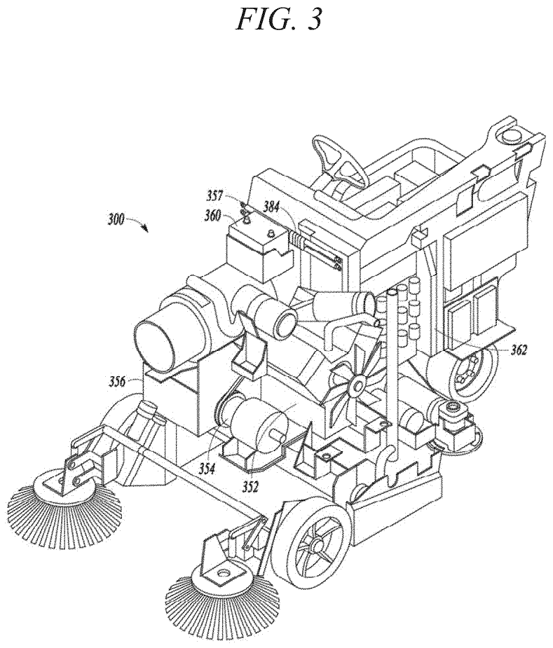

One illustrative but non-limiting example of the hybrid sweeper-scrubber machine of the present invention is illustrated in FIGS. 1 and 2. An illustrative schematic diagram of the hybrid sweeper-scrubber components is illustrated in FIG. 3. The sweeper-scrubber of FIGS. 1-3 provides the functionality of a sweeper-scrubber system through the use of electric components, although hydraulics can be used to operate the hopper for debris collection.

The present control method and system for the hybrid sweeper-scrubber can include an internal combustion engine and electrical system battery pack to power the hybrid sweeper-scrubber and operate a number of accessories and cleaning functions. The present control method and system can include components in electrical communication between the engine and electrical systems. Benefits of such embodiments can include reduced material costs, reduced component maintenance, reduced overall size of the hybrid sweeper-scrubber, elimination of a number of hydraulic components, lower emissions, or less fuel consumption.

FIGS. 1 and 2 are top and bottom perspective views, respectively, of an example of a sweeper-scrubber 30 that can utilize a scrub element retraction apparatus in accordance with the present patent application. As illustrated in FIGS. 1 and 2, the sweeper-scrubber 30 can include a sweeper system 32 for sweeping a floor surface and a scrubber system 34 for scrubbing the floor surface. Thus, as will be discussed in further detail below, the sweeper-scrubber 30 can be operable to sweep dirt and debris from the floor surface, spray a liquid cleaning solution from an onboard cleaning solution tank onto the floor being cleaned, and agitate the cleaning solution. Suction means can then be used to draw the cleaning solution into an onboard recovery tank.

Providing a floor cleaning system having both a sweeper system 32 and a scrubber system 34 can allow the operator to perform both “dry” and “wet” cleaning with the same system. These sweeping and scrubbing modes can be operated either separately or simultaneously depending upon the type of cleaning required.

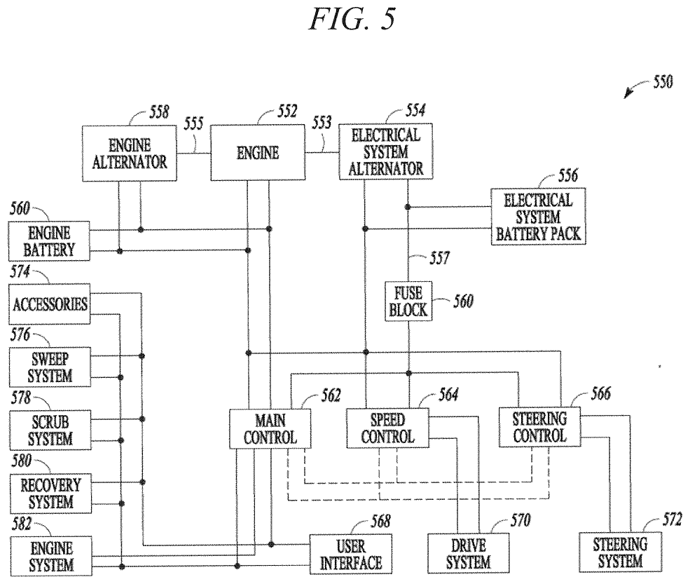

As further illustrated in FIGS. 1 and 2, the sweeper-scrubber 30 can include a chassis 36 supporting a machine body 37 and having a forward end 38 and a rearward end 40 joined by sides 42. The chassis 36 can be supported by one or more floor engaging front wheels 44 and one or more rear steerable wheels 46. The one or more rear steerable wheels 46 can be operatively connected to a steering wheel 48 through the chassis 36. Alternatively, the chassis can be supported by one or more front steerable wheels and one or more floor engaging rear wheels. The steering wheel can be part of a steering control system (e.g., 566, FIG. 5) as described herein.

A driver seat 50 can be supported by the machine body 37 rearward of the steering wheel 48 for use by an operator of the sweeper-scrubber 30. The operator can sit on the driver seat 50 to operate the steering wheel 48 and foot operated control pedals 52, such as a brake and an accelerator, supported above a chassis top surface 54 The accelerator can be included in a speed control system (e.g., 564, FIG. 5), as described herein.

In operation, a spray nozzle can spray a liquid cleaning solution from an onboard cleaning solution tank onto the floor being cleaned. The cleaning solution can be gravity fed through the spray nozzle, or alternatively pumped out of the cleaning solution tank through the spray nozzle. The spray nozzle can be integrated into a scrub sub-system (e.g., 578, FIG. 5), as described herein. The cleaning solution sprayed onto the floor can then be agitated by one or more ground engaging scrub elements 56A, 56B and 56C, such as scrub brushes. In an example, the scrub elements 56A-56C together form a portion of a scrub deck assembly 59 of the scrubber system 34 adjacent to a bottom surface of the chassis 36. As illustrated in FIGS. 1 and 2, the outside scrub element 56A and an associated skirt 57A can protrude from the side of the sweeper-scrubber 30 to improve scrubbing close to walls and other obstacles. As will be discussed in detail below, the outside scrub element 56A can be attached to a pivoting arm that can allow the scrub element 56A and the adjacent side skirt 57A to swing around a vertical axis, such that it can travel rearward and/or inward, to retract under the machine and prevent damage to the scrub deck assembly 59 caused by hitting obstacles. The scrub elements 56A, 56B, 56C and associated components can be part of a sweep sub-system (e.g., 576, FIG. 5), as described herein. A sub-system can include one or more electrical components. In some examples, the electrical components of the sub-system can be configured to perform one or more operations, motions or cleaning functions of the sweeper-scrubber 30.

As illustrated in FIGS. 1 and 2, one or more of the ground engaging scrub elements 56A-56C can have substantially parallel axes of rotation that are generally perpendicular to the floor surface. The scrub elements 56A-56C can be rotatably driven by a suitable motor and can be configured to agitate the cleaning solution sprayed onto the floor surface to dislodge dirt and grime adhered thereto. In addition to the scrub elements 56A-56C, the scrubber sub-system 34 can further include a floor engaging vacuum squeegee assembly 58 positioned proximal the chassis rearward end 40. The agitated cleaning solution and suspended dirt and grime can be drawn off the floor surface through the squeegee assembly 58 and into the recovery tank for disposal, such as with a recovery sub-system (580, FIG. 5), as described herein.

The squeegee assembly 58 can be coupled to a squeegee support bracket 60 pivotally attached relative to the chassis 36 and can be moved between an operating position and a stored position (when not in use). The squeegee assembly 58, which can be operable to dry the floor being cleaned by the sweeper-scrubber 30, can include a forward arcuate squeegee blade 62 nested within a rearward arcuate squeegee blade 64. In an example, the nested squeegee blades 62 and 64 can extend substantially across the width of the sweeper-scrubber 30 and can define a crescent shaped vacuum zone 66. The squeegee blades 62 and 64 can be formed from any flexible material that can sealingly engage the floor, including elastomeric materials such as rubber, plastic, or the like.

The forward squeegee blade 62 can be configured to collect the cleaning solution on the floor and can include notches in its floor engaging edge which allows the cleaning solution to enter the vacuum zone 66. The rearward squeegee blade 64 can include a continuous floor engaging edge in order to prevent the escape of the cleaning solution rearwardly from the vacuum zone 66.

As illustrated in FIGS. 1 and 2, a pair of side brushes 68 can be rotatably mounted proximal the chassis forward end 38 and forward of the ground engaging scrub elements 56A-C. The side brushes 68 can be driven by a suitable motor controlled by control circuitry. Each side brush 68 can be rotatable about a substantially vertical axis proximal one of the chassis sides 42, and can be configured to urge debris towards a centerline of the chassis 36 for pick-up by a main sweeper brush 69. In an example, the main sweeper brush 69 can be rotatable about a substantially horizontal axis. As illustrated in FIGS. 1 and 2, each side brush 68 can extend radially from its vertical axis past one side 42 of the chassis 36 in order to sweep the floor along a wall or other vertical or angled surface. Similar to the squeegee assembly 58, the side brushes 68 can be vertically movable between an operating position and a storage position.

FIG. 3 is an internal perspective of the hybrid sweeper-scrubber 30 of FIG. 1, the internal components shown as 300. As illustrated in FIG. 3, the hybrid sweeper-scrubber includes an internal combustion engine 352 that drives an electrical system alternator 354 via a suitable belt. The internal combustion engine 352 can include a number of combustible fuels including, but not limited to, diesel, natural gas, propane, ethanol, petroleum, and the like. The electrical system alternator 354 can be configured so as to start the engine and system of the hybrid sweeper-scrubber. In an example, the electrical system alternator can include a 42V alternator and regulator. The electrical system alternator 354 charges an electrical system battery pack 356 and can be operably coupled to a main controller 362, a speed controller (e.g., FIG. 5, 564), and a steering controller (e.g., FIG. 5, 566). The electrical system alternator can provide enough power so as to start the engine 352 of the hybrid sweeper-scrubber. The hybrid sweeper-scrubber can alternate between a number of running modes of the self-propelled hybrid vehicle, including at least an electric running mode and a hybrid running mode, the hybrid mode include running the engine on a combustible fuel and powering a number of cleaning functions (e.g., sub-systems) via the electrical system battery pack or electrical system alternator.

In an example, the electrical system battery pack 356 can include a number of 36V batteries. The main controller 362, speed controller, and steering controller are also coupled to the electrical system battery pack 352. The hybrid sweeper-scrubber can provide steering such as a wire steering system. A traction drive motor/system (e.g., sub-system) can be controlled by the speed controller. As described herein, engine speed can be controlled through the main controller 362, so as to adjust the engine operation to account for whichever cleaning functions are operating.

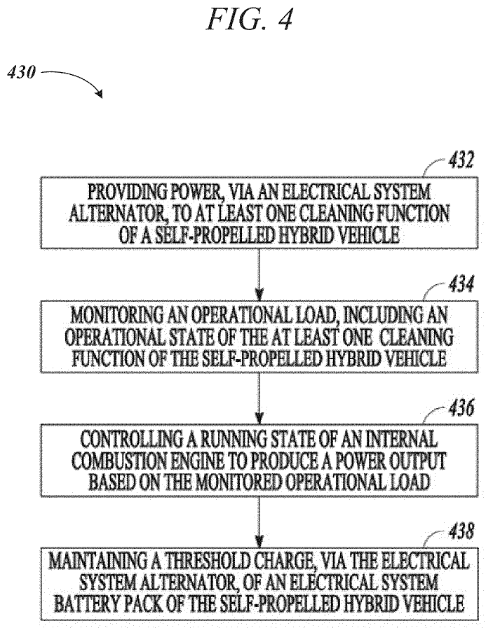

Now that an example of a floor cleaning system has been described that can utilize the control method of the present disclosure, the method and structure of an illustrative control method 430 will be described in detail with reference to FIGS. 4-5.

FIG. 4 illustrates of an example of a control method 430 of the hybrid sweeper-scrubber of FIG. 1. At 432, power can be provided, via an electrical system alternator (e.g., 354, FIG. 3), to at least one cleaning function of a self-propelled hybrid vehicle. A cleaning function can include a number of accessories or sub-systems including one or more electrical components configured to perform operations of the machine, as described herein in connection with FIGS. 1-3 and 5. Accessories can include a head light, signal lights, break lights, a horn, and the like.

At 434, an operational load can be monitored, including an operational state of the at least one cleaning function of the self-propelled hybrid vehicle. Operational load can include an engine power output threshold for the at least one cleaning functional to be operational. Operational state can include on/off or a percentage of full operational speed, power, torque, and the like.

At 436, a running state of the internal combustion engine (e.g., 352, FIG. 3) can be controlled based on the monitored operational load, so as to adjust the running speed of the internal combustion engine to a distinct running speed, so as to at least produce the monitored operational load. In an example, the running speed can be altered according to a number cleaning functions with an active operation state, so as to dictate an engine power output threshold for the at least one cleaning function to be in the active state. The running speed can be increased to provide greater power output than the monitored operational load due to a number of additional environmental impacts on the load, so as to provide enough power for the at least one cleaning function to remain in an active operational state. Environmental impacts can include, but are not limited to, inclined or declined surfaces, surface types (e.g., smooth, rough, uneven, etc.), or ambient temperature.

The running speed can include an idle speed, so as to provide power output sufficient to charge the electrical system battery pack or operate an operational accessory. A threshold engine speed can be maintained for a number of cleaning functions to operate during a manual adjustment of the running speed of the engine, such as by an operator of the hybrid sweeper-scrubber. For example, the operator is able to increase and decrease the engine speed at will, but the main controller will not allow the engine to run slower than a power output needed for the operational cleaning functions.

In some examples, the control method and control system can regulate engine speed or revolutions per minute (RPM) at a number of settings based on the number of operational cleaning functions, such as by monitoring the active cleaning functions that are in operation. The RPMs can be set at distinct values. For example, if only the sweep sub-system (e.g., 376, FIG. 5) is operational then a lower sweep RPM setting (RPM Setting #1) of the engine can be activated, such as about 1700 RPM to about 2500 RPM. However, if both the sweep sub-system and scrub sub-system (e.g., 378, FIG. 5) are being operated, then an RPM setting (RPM Setting #2) higher than the lower sweep RPM setting on the engine can be activated, such as greater than about 2700 RPM.

The control method and system can regulate the engine speed based on a number of modes, including but not limited to: optional high pressure washer option can cause the engine to run at a lower RPM mode (RPM Setting #1); if the engine is in idle (RPM Setting Idle), the engine can run at a lower RPM mode (RPM Setting #1) when sweeping only or vacuuming only; if the engine is in idle or run, the engine can run in a higher RPM mode (RPM Setting #2) when scrubbing only or scrubbing and sweeping; if an operator override is activated, the operator can change between a higher RPM mode (RPM Setting #2) and a lower RPM mode (RPM Setting #1) at the operator's discretion; or, if the operator override condition goes away (e.g. sweep sub-system turns off) and the operator has not changed the engine mode, the engine can be returned to the mode before the forced override.

At 438, a threshold charge can be maintained, via the electrical system alternator (e.g., 154, FIG. 3), of the electrical system battery pack (e.g., 156, FIG. 3). For example, the amount of voltage stored in the electrical system battery pack can be maintained or optimized while the engine is running or the hybrid sweeper-scrubber is operational.

The electric mode can include monitoring the electrical system alternator for an occurrence of an electrical component fault, such as a voltage below a threshold voltage or an indication of a belt failure. The electrical system alternator can be monitored per a set time interval or continuously. Protective measures can be taken if the occurrence of an electrical component fault is detected, such as providing a warning to an operator, shutting down the self-propelled hybrid vehicle, or the like.

The hybrid mode can include monitoring the self-propelled hybrid vehicle for an occurrence of an engine component fault, such as the engine runs out of fuel, if the engine fails, if the engine generator fails, if the belt from the engine to engine alternator fails, etc. The running mode can be shifted to the electric mode if the occurrence of an engine component fault is detected. As described herein, the running mode can be altered by an operator if an override mode is activated.

If the machine is operating from the electrical system battery pack only, such as due to a failure in the engine or engine alternator as discussed herein or by operator override, the control system can monitor battery voltage of the electrical system battery pack until a threshold voltage condition is met. At such point, the control system can protect the hybrid sweeper-scrubber by shutting off machine cleaning functions and shutting down the hybrid sweeper-scrubber.

FIG. 5 shows an illustrative schematic diagram 550 of various electrical components 310 that can be provided on the hybrid sweeper-scrubber of FIGS. 1-3. Like numerals in FIGS. 3 and 5 can represent like components. For example, internal combustion engine 352 in FIG. 3 corresponds to the electrical aspect of the engine shown as engine system 552 in FIG. 5.

The internal combustion engine 552 can be operably coupled to an electrical system alternator 554, such as via a belt 553. The electrical system alternator 554 can be configured to charge an electrical system battery pack 556 and operably coupled to a number of controllers 562, 564, 566. In an example the electrical system alternator 554 can be operably coupled to or through a fuse box 560. The number of controllers 562, 564, 566 can be operably coupled to the electrical system battery pack 556. Controller 564 can include a speed controller operably coupled to a drive system 570, so as to control the speed of the hybrid sweeper-scrubber. Controller 566 can include a steering control operably coupled to a steering system 572 (e.g., steering sub-system), so as to steer or provide directional capabilities to the hybrid sweeper-scrubber. Controller 562 can include a machine main controller (MMC) that is operably coupled to the internal combustion engine and configured to control a running state of the engine 552 of the self-propelled hybrid vehicle based on a monitored operational load. The main controller 562 can be operably coupled to any of a user interface 568, an accessory 574, or a number of sub-systems 576, 578, 580, 582, directly or indirectly. The user interface 568 can be configured so as to indicate a status of a sub-system, a measurement, an alarm, a time, or the like. The MMC 562 can be configured to monitor the electrical system alternator 554 to detect failures, as described herein.

The sub-systems can include any of a sweep sub-system 576, a scrub sub-system 578, or a recovery sub-system 580, as described herein. Further, the control method and system can include an engine system 552, such as an engine controller controlled by the MMC 562 or a computer processing unit associate with control logic for operation of the engine 552 (e.g., engine 352, FIG. 3).

An engine alternator 558 can be operably coupled to an engine battery 360, so as to start the internal combustion engine 552, as described herein.

A switching component can also be provided that can be configured to alternate the self-propelled hybrid vehicle between a number of running modes, the number of running modes including at least an electric mode and a hybrid mode, as described herein. A running state override switching component can be configured to override an operator initiated running state if the operator running initiated state is below a threshold run state based on the monitored operational load, as described herein.

In an example, the hybrid sweeper-scrubber can include a regenerative braking method or system to improve fuel efficiency, such as providing charge to the electrical system battery pack. The hybrid sweeper-scrubber control method and system can include a data acquisition system, so as to provide a number of measurements used in charge algorithms, running speed algorithms, failure mode detections, and the like.

The main alternator in the hybrid sweeper-scrubber can be sized to provide power to all of the cleaning functions of the machine, with the exception of the engine system, and for maintaining a charge on the main system battery pack during operation. The main system battery pack provides a “buffer” to handle the inrush currents and heavy load currents that exceed the capacity of the main alternator. Such “heavy loads” can be caused by sweeping/scrubbing up inclines, etc. Additionally, the main system battery pack is not merely a “back-up” source of power. Rather, the sweeper-scrubber is fully operational in the battery-operated mode for an extended period of time, such as the duration of the charge.

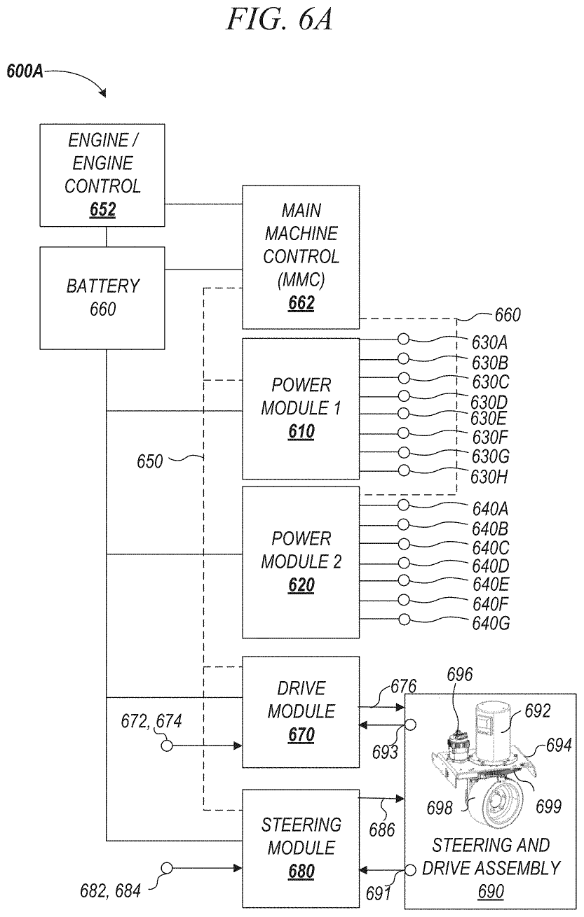

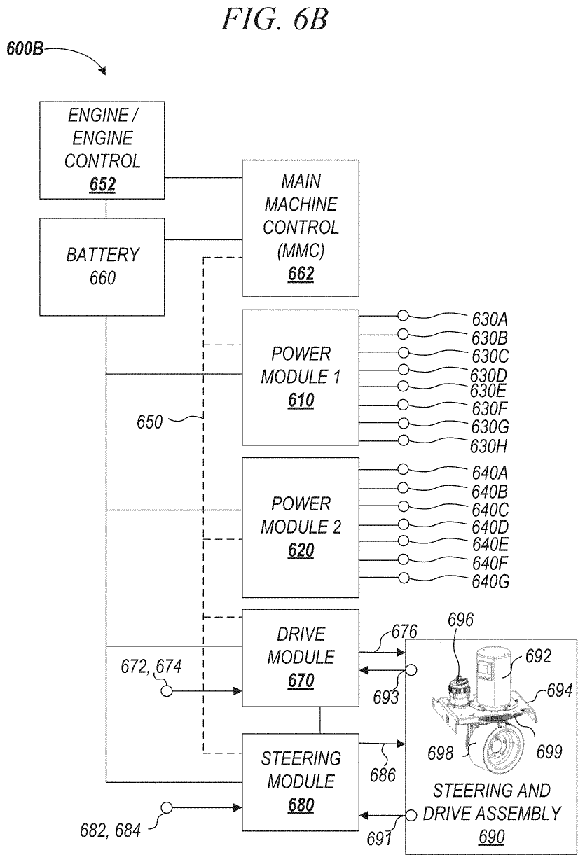

FIG. 6A is a functional diagram of aspects of another example control system 600A including an MMC operably coupled to an engine and a power module 610 operably coupled to the MMC 662 via a controller area network (CAN) bus 650. In the present example, two power modules 610, 620 are provided, each having respective CAN buses 650, 660 (FIG. 6A), however, any suitable number of power modules (e.g., one or more) can be provided. One of the benefits of using two smaller power modules in place of one larger power module is that cost can be reduced, and modularity can be improved.

The one or more power modules 610, 620 can be used with a machine such as, but not limited to, the hybrid sweeper-scrubber machine 30 of FIG. 1, in accordance with at least one example. In contrast to the control system 500, instead of the MMC 562 communicating directly with the sub-systems (e.g., 576, 578 and 580), in the example of FIGS. 6A and 6B, the one or more power modules 610, 620 can control the high-power motors 630A-C, 640A-C of the control system 600A. In other words, the power modules 610, 620 can handle the high-power output functions for the machine 30 and communicate information back to the MMC 662, while the main control function of the overall machine can be provided by the MMC 662. The power modules 610, 620 can send and receive commands from the MMC 662 via the one or more CAN buses 650, 660. CAN bus networks will be described in further detail later in this disclosure.

The power modules 610, 620 can receive logic power from an alternator (e.g., 558, FIG. 3). When more than one power module is provided, each of the power modules 610, 620 can have control of its own high-power input from a respective relay between the MMC 662 and the respective power module 610, 620.

In the example of FIGS. 6A and 6B, the power modules 610, 620 can monitor the performance, operation and health of a sub-system including one or more electrical components such as one or more of the motors 630A-C, 640A-C, and communicate a status back to the MMC 662 via the CAN buses 650, 660. In other words, the power modules 610, 620 can provide basic motor control and protection, while the MMC 662 can control the actual operation commands of the overall machine including the motors 630A-C, 640A-C. In some examples, the power modules 610, 620 can be configured to not have any direct inhibit signals (such as a seat switch or an emergency stop signal), except by commands provided on the CAN buses 650, 660.

A benefit of the control system of FIGS. 6A and 6B is that the power modules 610, 620 can monitor the current across one or more electrical components (e.g., any of 630A-630H, 640A-640G) without the need for having individual current sensors. The power modules 610, 620 can control one or more motors or other electrical components including actuators (e.g., one or more of 630A-H, 640A-H) that power brooms 630D, fans 630E, vacuums 630F, dump doors 630G, shakers 630H, hoppers 640D, brushes 640E, squeegees 640F, decks 640G, among other functions.

Another feature of the control systems 600A and 600B is that the power modules 610, 620 can communicate information about the one or more electrical components of one or more sub-systems to the MMC 662, and the MMC 662 can then automatically increase or decrease the engine revolutions per minute (RPM) based on the overall load (e.g., current draw) in addition to considering the current functional mode (e.g., operational state) of the machine 30. This can improve the overall functionality of a sweeper-scrubber machine 30 as compared to a conventional machine that only sets an engine RPM default value based solely on an estimate of the load corresponding to the selected functional mode of the machine 30 or manual override, without consideration of other power demands, including environmental demands that can affect the machine 30.

In some examples, a sub-system can include one or more electrical components. In some examples, the sub-system can include a plurality of the same type of component for the same purpose, such as a plurality of motors that each operate a scrub brush. In some examples, a sub-system can include combination of different electrical components that serve different purposes. For example, a sub-system can include a combination of different types of electrical components, such as a motor to operate a broom or a brush, and an electrical component such as a fan or a pump to operate a vacuum.

In some examples, the sub-systems are not organized or arranged solely by function. For example, even though the machine can include a plurality of the same type of component, such as a plurality of scrub motors 630A-630C, in an example, scrub motor 630A can be included in the subsystem of the first power module 610, while scrub motor 630B can be included in the subsystem of the second power module 620. One benefit of such an arrangement is that it allows balancing of loads on the first power module 610 and the second power module 620.

The control system of FIGS. 6A and 6B can eliminate the need for the operator to monitor and recognize a need for more power and then manually choose to increase the engine 652 RPM when there is a high-power requirement. Instead, the power modules 610, 620 can monitor the current across the electrical components (e.g., modules, sub-systems, motors) 630A-H, 640A-G of the control systems 600A or 600B, and send a message to the MMC 662, which can determine and enable automatic power adjustment when needed. Environmental demands that can require additional power include, for example, when the machine 30 is going up an incline or over a rough surface. In conventional systems, which can only estimate a load of a particular functional mode, the added power required to go up an incline or rough surface is not monitored in real-time and the machine becomes at risk of stalling or otherwise failing.

In addition to the power modules 610, 620, other modules can be operably connected to the MMC 662, such as a wheel drive module 670 and a steering module 680. The wheel drive module 670 and the steering module 680 can power steering and drive assembly 690. The power steering and drive assembly 690 can include a drive motor 692, a body or frame 694 a steering motor 696, a drive wheel 698, and a steeling drive 699.

In some examples, the wheel drive module 670 and/or the steering module 680 can also be power modules and function in the same or similar manner as power modules 610 and 620. In other words, the wheel drive module 670 and steering module 680 can also be provided as power modules that can monitor the current across one or more electrical components electrically connected to the wheel drive module 670 or the steering module 680, without the need for the MMC 662 to monitor individual current sensors.

A drive sensor 672 of a drive input 674, such as a “gas pedal”, can provide an input to the wheel drive module 670. Upon receiving an input from the drive sensor 672, the drive module 670 can send power (e.g., via a wire 676) to the steering and drive assembly 690 to operate at least a portion of the steering and drive assembly 690.

A steering sensor 682 of a steering wheel 684 can provide an input to the steering module 680. Upon receiving an input from the steering sensor 672, the steering module 680 can send power (e.g., via a wire 686) to the steering and drive assembly 690 to operate a portion of the steering and drive assembly 690.

Frame 694 can be a rigid member secured to a chassis or body of a scrubber-sweeper or motive machine and can be comprised of rigid materials such as metals, plastics, combinations thereof, and the like. Drive motor 692 can be a three phase AC motor secured to body 694, coupled to drive wheel 698 to transmit rotation thereto, and controlled via drive input 674 and drive module 670. Steering motor 696 can be a three phase AC motor coupled to steering drive 699 and can be secured to body 694. Steering motor 696 can be communicably coupled to steering module 680, in some examples. Drive wheel 698 can be rotatably coupled to body 694 and can be mechanically coupled to steering motor 696. Drive motor 692 can be engaged with drive wheel 698 (through a hub or linkage system, for example) to transmit rotation thereto.

In operation of some examples, power can be controllably transmitted to the drive motor 692. In response, the drive motor 692 can produce a rotational output that is transmitted to the drive wheel 698, which can thereby rotate to drive or move the motive machine. When it is desired to turn the motive machine, an operator can rotate the steering wheel 674. As the steering drive 699 rotates, a steering sensor (e.g., 691) can detect the rotation and transmit a signal to steering module 670. Steering module 670 can output a pulse width modulated (PWM) signal to steering motor 696 to rotate drive wheel 698. In response, the steering motor 696 can transmit electrical power thereby transmitting rotation to steering drive 699. As steering drive 699 is rotated about its central axis by steering motor 696, drive wheel 698 can rotate as well.

The wheel drive module 670 can control the drive motor 692 of the machine based on commands from the drive input 674 (e.g., operator foot pedal), the MMC 662 and feedback from the drive motor 692 itself (e.g., drive motor load). The drive motor 692 load can be measured in real time by drive motor load sensor 693 which can be monitored by drive module 670 without the need for the MMC 662 to monitor individual current sensors. Furthermore, in contrast to conventional scrubbing machines, which estimate a theoretical load on a drive motor. The drive motor 692 load can be individually monitored in real time and the monitored load can be used to control or automate engine 652 RPM in real time, and to provide more power to the drive motor 692 as needed. The MMC 662 can make a determination based on the real time drive motor 692 load to provide more power to the drive motor 692, for example, when the machine is driving up an incline, ramp or over a rough surface.

By monitoring drive motor 692 load in real time, over loading, shut down or failure of the machine can be reduced. Benefits of the drive module and 670 and steering module 680 include that loads on the other components of the steering and drive assembly 690 can be monitored in real time. This can occur without the need for the MMC 652 to monitor individual current sensors and control of the engine 652 RPM in real time or providing more power to components of the steering and drive assembly 690 can be achieved.

In some examples, sensors such as 691 and 693 may provide input to the steering module or the drive module to aid in decision making and control of the engine 652 RPM, and the components of the drive module 670 and/or the steering module 680. A variety of sensors can be included in the assembly 690, for example, steering sensors, temperature sensors, load sensors, voltage sensors and rotation sensors.

The steering module 680 can control the steering motor 696 based on commands from the operator steering wheel 684 via sensor 682 and feedback from the steering motor 696 and one or more sensors 691, such as steering limit switches. The steering module can also enable or disable the drive function (e.g., drive motor 692) if the steering system is not ready to move the machine.

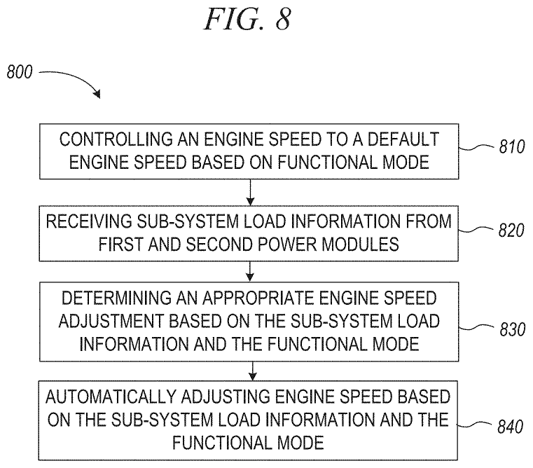

An engine control module can monitor engine functions and communicate with the MMC 662 to provide engine status to the MMC 662, in some cases an engine controller can be integral to the engine and can operate and monitor engine functions semi-autonomously. Control of the engine speed will be further described with respect to the method 800 of FIG. 8

As previously described in FIGS. 6A and 613, the power modules 610, 620 can be connected to the MMC 662 via one or more CAN bus networks 650, 660. In some examples, the power modules 610 and 620 can be connected to the MMC, separately, communicating on different CAN bus 650, 660 (FIG. 6A). In other examples, the power modules 610 and 62.0 can be connected to the MMC 662 on the same CAN bus 650 (FIG. 6B). The MMC 662 can provide commands to other controllers directing them to complete their associated tasks. The MMC 662 can also directly (or indirectly) control many of the low-power motors and devices such as one or more of a detergent pump, a scrub pump, a dust guard pump or valve, a solution pump, a horn, a backup alarm, a solution valve, and lights. The MMC can also monitor many of the system sensors, such as: detergent pumps, scrubber pumps, dust guard pumps and valves, solution pumps and valves, horns, back up alarms, hydraulic clutches, headlights, turn signals and tail lights, as well as components of the steering and drive assembly 690. The MMC 662 can receive input about dump door open/close status, dump door position, broom position, a hopper fire, brake pedal on/off, dust control filter, exterior scrub empty/full, hopper interlock, e-stop, seat switch and battery interlock.

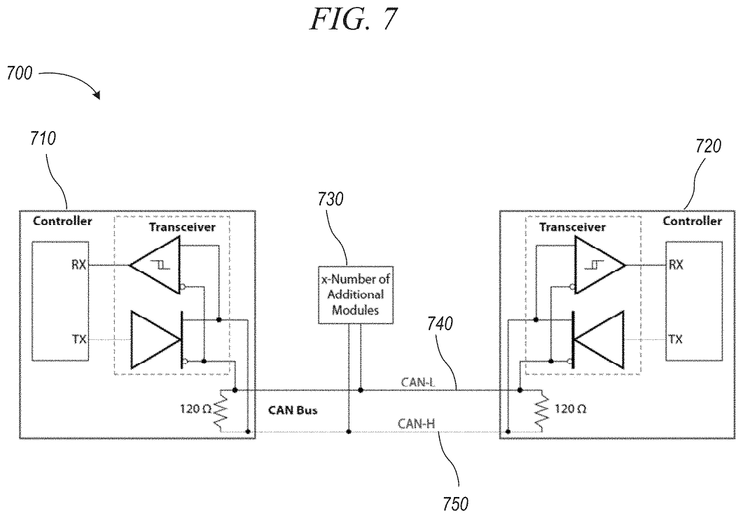

A general description of CAN bus networks 700 will now be described with reference to FIG. 7. CAN bus communication can allow distributed modules 710, 720, 730 to communicate with each other over a single serial channel without any single module being the master of the communication channel. This means that each module can broadcast what it has to say, and all the other modules on the CAN bus network 700 can see the message, but pay attention only to those messages they need to know about. In some examples, more than one CAN bus can be provided.

The CAN bus is a twisted-pair of wires 740, 750 running between the distributed modules 710, 720, 730 (and such as the modules of FIGS. 6A and 6B), with one wire being low 740 and the other wire high 750, voltage-wise. To send a data bit the module pulls the high and low wires apart, voltage-wise. All of the other modules monitor this to detect a communication message, which is a string of low and high binary pulses. However, the binary logic states are reverse of typical, in that a logic-1 is recessive and the difference between CAN-high and CAN-low (e.g., near zero). A logic-0 is the dominant bit, and the difference between CAN-high and CAN-low is high (e.g., approximately 2.5 volts).

Because none of the distributed modules 710, 720, 730 represent the master of the CAN bus network 700, any of the distributed modules 710, 720, 730 can initiate a CAN bus transmission any time there is not already traffic on the CAN bus 700. When the module detects inactivity on the CAN bus 700, it transmits a dominate bit, and begins sending the message priority level bits. But at the same time, it is also monitoring the bus itself to detect if a higher priority message was being initiated at the same time. The message with the higher priority level will have the bus high for the longest period, and therefore, that module knows that it is sending the highest priority message. The other module ceases its transmission and waits until the CAN bus is available again.

Generally, most CAN bus 700 messages originate from the main controller (e.g., MMC 662, FIGS. 6A and 6B), or in response to a request from the MMC. However, each module can send emergency messages at any time.

FIG. 8. shows an illustrative method 800 of controlling a motive machine (e.g., 30, FIG. 1) in accordance with at least one example. The method 800 can be used with, but is not limited to, the example control system 600 including CAN buses 650, 660 of FIG. 6.

According to the method 800, the MMC (e.g., 662, FIG. 6) can control the overall operation of the machine 30 based on inputs received from the first and second power modules 610, 620, the wheel drive module 670, the steering module 680 and the engine control module 652, as well as any other suitable inputs. Using this information, the MMC (e.g., 662, FIG. 6) can control operation of the machine 30, including controlling an engine speed. Engine speed can be measured in revolutions per minute (RPM). The method 800 will be described mainly with respect to the machine 30 of FIGS. 1-3 and the control system of FIG. 6.

Operation 810 of the method 80( )can include controlling, based on a selected functional mode of the machine 30, an engine RPM to a default engine RPM.

Operation 820 can include the MMC 662 receiving, from the power module 610, load information corresponding to a load of a sub-system having, for example, one or more motors 630A-C that are operably coupled to the power module 610. The power module 610 can communicate load information to the MMC 662 via the first CAN bus 650.

In some examples, as shown in FIGS. 6A and 6B, multiple power modules 610, 620 can be provided and can communicate current load and other information to the MMC 662 over the same or respective CAN buses 650, 660, in order to control engine speed and the other functions of the machine 30. For the sake of brevity, the method 800 will be described with respect to a system/machine having one power module 610.

Operation 830 can include automatically adjusting the engine speed (e.g., rpm) not based solely on the selected functional mode of the machine 30, but also based on the sub-system (e.g., motors 630A-C) load information received from the power module 610. In a method having two power modules, the load information from the second power module 620 can be added to the load information from the first power module 610 in determining the automatic adjustment.

One benefit of increasing or decreasing the engine speed based on actual, real-time monitored sub-system load information, received from a power module 610, is that engine speed control becomes more automated, which improves the user's experience by simplifying use and improving performance. When engine speed is automatically controlled, the user does not have to manually modify the engine speed. This means the user does not have to have as much knowledge about operation of the machine, increasing ease of use and improving performance. In addition to improving the user's experience, by using the power modules, the method 800 is able to do so without external current sensors for each electrical component, resulting in decreased manufacturing cost.

Some example automatic adjustments in engine speed according to the method 800 will now be described. For example, a machine operating in one or more functionals modes such as in the transport, sweep or recovery functional modes can operate at a default RMP of 2500. If, while monitoring the load of the various sub-systems (e.g., one or more of motors 630A-C, FIGS. 6A and 6B or other electrical components) of the machine (e.g., 30, FIG. 1), the MMC (e.g., 662, FIGS. 6A and 6B) determines, based at least in part on information from the power module (e.g., 610, FIGS. 6A and 6B) that the load monitoring is greater than 100 Amperes, the RPM can be automatically increased to 2700 RPM. The MMC 662 can continue to monitor the load received from the power module 610, and when the amperage drops, the RPM can reduce back to 2500 RPM.

In another similar example, a machine operating in the transport mode at a default of 1700 RPM experiences a load monitored by the power module 610 that is greater than 60 Amperes. To compensate, the MMC 662, can automatically increase the RPM of the engine 653 to 2500 RPM, and then gradually reduce back to 1700 rpm as the load monitored by the power module 610 drops. The one or more functional modes can include any one or more of transport, sweep, scrub, idle or recovery, or any other suitable mode or function of the machine.

In the control system of FIGS. 6A and 6B, the power module 610 can monitor the load (e.g., current draw) on individual scrub motors 630A-C. The inventors have discovered, that typically, when there is an overload, it is only one of the scrub motors that is going through the overload, while the other scrub motors are still under loaded.

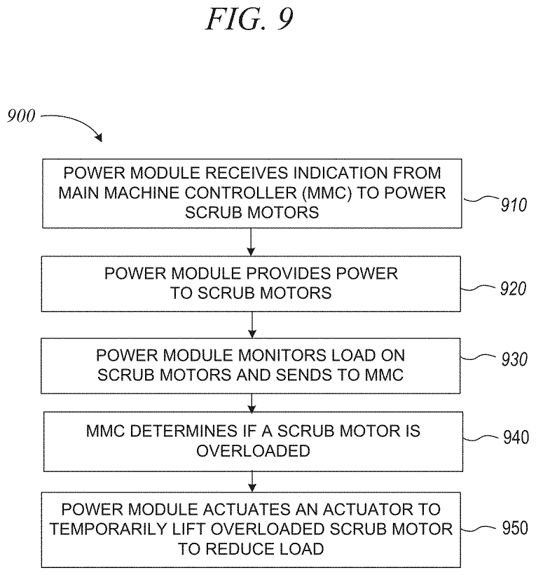

As shown in FIG. 9, method 900 can include a power module 610 that monitors the current draw from one or more of the individual scrub motors 630A-C and can reduce the load on a specified motor if the MMC 662 determines, based on the monitored current received from the power module 610 that the specified motor (e.g., one of 630A, 630B or 630C) is overloaded (e.g., transgressed or exceeded a load threshold). The scrub motors 630A-C represent merely one example of an electrical component, the method 900 can be performed with other electrical components and sub-systems of the machine besides the scrub motors 630A-C.

The method 900 of FIG. 9 can be performed using the sweeper-scrubber machine 30 of FIGS. 1 and 2., having, for example, one or more of scrub elements 56A-C (FIG. 2) operated by the one or more scrub motors 630A-C (FIGS. 6A and 6B). However, any number of scrub motors and elements can be provided, including a plurality of scrub motors and scrub elements or a singular scrub motor and scrub element, or unequal numbers of scrub motors and scrub elements.

Operation 910 of the method 900 can include the power module 610 receiving an indication to provide power to one or more of the scrub motors 630A-C (FIGS. 6A and 6B). Operation 910 can occur when a user selects the scrubbing functional mode of the machine 30.

In response to receiving an indication to provide power, operation 920 can include the power module 610 providing power to the scrub motors 56A-C.

Operation 930 can include monitoring a load (e.g., current load) on one or more of the scrub motors 56A-C with the power module 610. Based on the monitoring conducted in operation 930, operation 940 can include the MMC determining that one or more of the scrub motors 630A-C is overloaded such that the current load on the scrub motor has transgressed a threshold (e.g., exceeding a specified current or voltage).

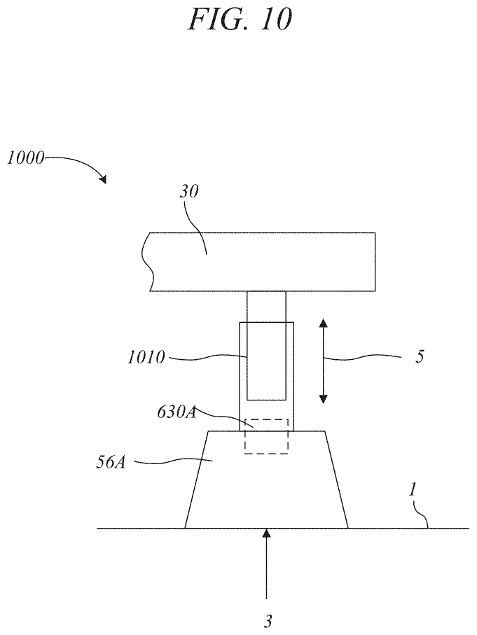

If in operation 940, the MMC determines that a motor is overloaded, then in operation 950, the power module 610 can actuate an actuator 1010 (FIG. 10) to temporarily lift the overloaded scrub element (e.g., 56A, FIG. 10) in order to reduce the load on the overloaded motor (e.g., 630A, FIG. 10). Lifting the scrub element 56A decreases the normal force 3 that is exerted on the scrub element 56A by the ground 1. This temporary lifting action 5 of the scrub element 56A by the actuator 1010 can protect the motor from damage.

FIG. 10 illustrates an example arrangement of an actuator 1010 that can perform the lifting action 5 of the method 900. As shown in FIG. 10, the actuator 1010 can lift both the scrub element 56A and the motor 630A. However, in some examples, the actuator 1010 can be arranged relative to the scrub motor 630A and the scrub element 56A so that just the scrub element 56A is lifted, with the motor 630A remaining stationary in a fixed relationship with the frame of machine 30.

In an example, an actuator can be provided with any of the electrical components in order to move the electrical component to prevent overloading on a motor. The actuator can move individual motors and other electrical components such as a scrub motor as previously described, but an actuator can also be used with, for example, a sweeping motor, a vacuum motor, a vacuum squeegee, a deck, a steering element, a traction element, a fan, a dust collector or a broom. An actuator can be provided with any suitable electrical component that can be prevented from overloading by a lifting action. In some examples, one actuator can move a plurality of electrical components together, such as moving a plurality of scrub elements.

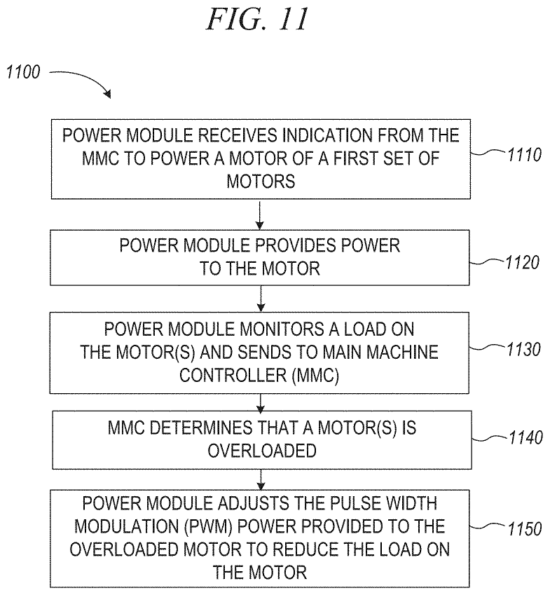

In addition to the method 90( )of reducing a load on a scrub motor 630A by lifting the scrub element 56A with an actuator 1010 as depicted in FIG. 10, the load on a scrub motor, or any other type of motor, can be accomplished by other methods described herein. For example, FIG. 11 shows a method 1100 where a load reduction on a motor can be accomplished by adjusting a pulse width modulation (PWM) power supplied to the motor. For example, the PWM power delivered to a motor that is overloaded can be adjusted such that the power delivered to the overloaded motor is reduced. This results in the overloaded motor running at a lower RPM and therefore less load.

PWM can be applied to other components besides motors, PWM can be used to control the output voltage for any of the electrical components irrespective of the input voltage from the battery. Using PWM, the life of motors, including scrub motors and vacuum motors, can be improved in less demanding applications, as they can be operated at a lesser voltage when the application does not require it. A second benefit of using PWM is that it can help modularize manufacturing by allowing the same motors to be used across different machines that have different batteries (e.g., different voltage power packs).

For example, as shown in FIG. 11, a load reduction on a motor can be accomplished by a method of monitoring and powering of motors via a power module. Example method 1100 of FIG. 11 will be described with reference to the control system of FIGS. 6A and 6B, but can be used with other control systems having a different number and arrangement of power modules, and sub-systems including one or more motors or other electrical components.

Operation 1110 of the method 1100 can include a power module 610 receiving an indication to power one or more motors of a set of motors 630A-C from the MMC 662.

Operation 1120 can include the MMC 662, via a power module 610, providing power to at least one of the one or motors 630A-C that are operably coupled to the power module 610.

Operation 1130 can include the power module monitoring a load on at least one of the one or more motors or other electrical components.

Operation 1140 can include the MMC determining, based on the monitored load received from the power module 610, that the load on one of the monitored motors has transgressed a load threshold (e.g. overloaded). The load threshold can be measured as a current load.

Operation 1150 can include that if the load threshold has been transgressed by any one of the one or more motors, adjusting the PWM power provided to the overloaded motor to reduce an output thereof.

Although not required, in the example control system of FIGS. 6A and 6B, there are two power modules and two sets of motors. In an example, a first power module 610 is operably coupled to one or more of a first set of motors 630A-C, and a second power module 620 is operably coupled to one or more of a second set of motors 640A-C. In examples having multiple power modules, the methods described herein can be applied to one or both power modules.

For example, the method 1100 can be applied not just to a power module 610 (e.g., first power module), but also a second power module 620 can receive an indication to power one or more motors of a second set of motors 630A-C that are operably coupled to the second power module 620. Method 1100 can further include providing power, with the second power module 620 by PWM to the one or more motors 640A-C of the second set of motors, as shown in the control system 600A or 600B of FIGS. 6A or 6B.

If the second power module 620 communicating to the MMC, while monitoring a load on one or more motors 640A-C of the second set of motors, results in the MMC determining that any of the one or more motors of the second set of motors has transgressed a second load threshold, the second power module, via communication from the MMC, can adjust the power provided to the motor that transgressed the second load threshold. Adjusting the power by PWM can reduce the output of the motor that transgressed the second load threshold to reduce the output thereof.

The control system of FIGS. 6-11 provides numerous advantages including, but not limited to, the ability to provide automated power management without the need for external current sensors for individual components. The present disclosure results in improved automated power management, a reduction in the number electrical components that is required to do so, and increase in the life of and durability of the machine.

The control system and method described herein can be executed by at least one non-transitory machine-readable medium including instructions for a main machine controller (MMC) to operate the control system for the motive machine. The motive machine having a power module and a sub-system (e.g., power module 610, one or more of motors 630A-C, FIGS. 6A and 6B).

The instructions, when executed by a processor, can cause the processor to: 1) control, based on a selected function mode of the machine, an engine speed of an engine to a default engine speed; 2) receive, from the power module via the CAN bus, load information corresponding to a load of one or more electrical components of the sub-system; and 3) automatically adjust the engine speed based on the sub-system load information and the selected functional mode of the machine.

The machine-readable medium can further cause the processor to monitor, with the power module, a current load on the scrub motor, and if the MMC determines that the current load on the scrub motor has transgressed a threshold, cause the actuator to be actuated to lift the scrub element to reduce the load on the motor by decreasing the force on the scrub element.

The machine readable medium can further cause the processor to: 1) receive, from the power module via the CAN bus, an indication to power one or more motors of a first set of motors that are operably coupled to the power module; 2) provide power, with the power module, by pulse width modulation (PWM) to the one or more motors; 3) monitor, with the power module, a load on the one or more motors; 4) determine, with MMC, if any of the one or more motors transgressed a load threshold; and 5) if the load threshold has been transgressed by any of the one or more motors, adjust, with the power module, the power provided to the motor that transgressed the load threshold to reduce an output thereof.

The processor can also apply similar instructions to the second power module operably coupled to the MMC by the second CAN bus. The processor caused to: 1) receive an indication, at a second power module, to power one or more motors of a second set of motors that are operably coupled to the second power module; 2) provide power, with the second power module, by pulse width modulation (PWM) to the one or more motors of the second set of motors; 3) monitor, with the second power module, a load on one or more motors of the second set of motors; 4) determine, with the MMC, if any of the one or more motors of the second set of motors has transgressed a second load threshold; and 5) if the second load threshold has been transgressed by any of the one or more motors of the second set of motors, adjust, with the second power module, the power provided to the motor that transgressed the second load threshold to reduce an output thereof.

The instructions, when executed by a processor, can also cause the processor to perform one or more, or at least two of: sweeping, scrubbing, recovering, idling and transporting, depending on the functional mode of the machine selected by the user.

To protect the machine 30 (FIG. 1) in the case of a short in the machine, a solenoid 1300 may be provided that can be associated with a power module (such as the previously described power modules 610, 620 described with respect to FIGS. 6A and 6B).

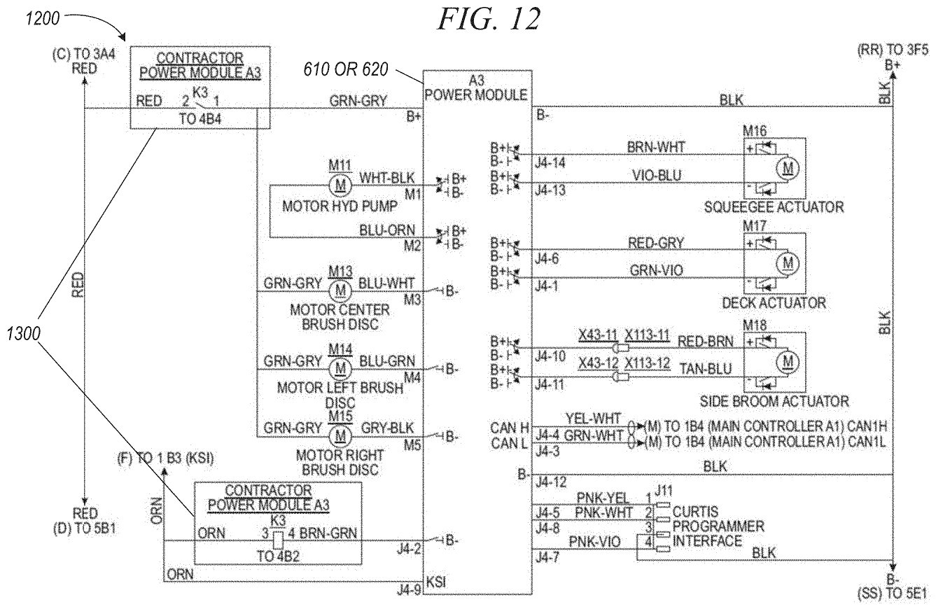

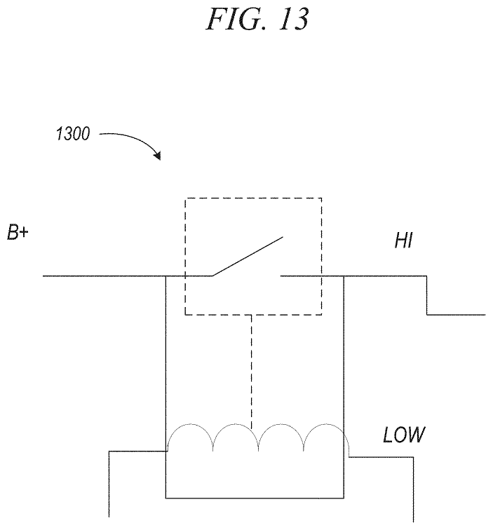

FIG. 12 shows an example of the overall operation of a solenoid 1300 corresponding to an example power module schematic 1200. The solenoid 1300 is identified in the two boxes in FIG. 12, and the solenoid 1300 shown in further detail in FIG. 13. In an example where the machine includes multiple power modules, multiple solenoids can be provided, a solenoid corresponding to each power module.

In the example of FIGS. 12 and 13, the fail-safe works by the machine not switching on output from a power module (e.g., 610, FIG. 10) until a high side current switch (FIG. 13, HI) of the solenoid closes. The solenoid 1300 closes after power on self-tests of the machine have been successfully completed and no shorts or errors have been identified. If a short or error is identified, the solenoid 1300 does not close in order to protect the rest of the machine 30 in the event that any of the individual components of the machine have a severe fault or short.

### VARIOUS NOTES AND EXAMPLES

To better illustrate the devices and methods disclosed herein, a non-limiting list of embodiments is provided herein.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein,” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) can be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features can be grouped together to streamline the disclosure. This should not be interpreted as intending that an unclaimed disclosed feature is essential to any claim. Rather, inventive subject matter can lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

Example 1 is a motive machine comprising: an engine; a main machine controller (MMC) operably coupled to the engine; a power module operably coupled to the MMC; and a sub-system including a motor, wherein the motor is operably coupled to the power module by the CAN bus, wherein the power module monitors a load of the sub-system, and using the monitored load of the sub-system, the power module communicates sub-system load information to the MMC, wherein if the MMC determines that the current load on the motor has transgressed a threshold, the MMC, through the power module, takes an action to reduce the load on the motor.

In Example 2, the subject matter of Example 1 optionally includes wherein the motor is a scrub motor having a scrub element that is movable by an actuator, and if the MMC determines that the current load on the scrub motor has transgressed the threshold, the MMC, through the power module, actuates the actuator to lift the scrub element to reduce the load on the scrub motor.

In Example 3, the subject matter of any one or more of Examples 1-2 optionally include wherein the sub-system includes a plurality of individual scrub motors that are operably coupled to the power module, and one or more of the individual scrub motors has a scrub element that is movable by an actuator, and wherein the power module monitors a current load on the individual scrub motors and communicates the current load to the MMC, and if the MMC determines that the current load on one of the individual scrub motors that has an actuator has transgressed a threshold, the MMC, through power module, actuates the actuator for that scrub element to lift the scrub element to reduce the load on the scrub motor.

In Example 4, the subject matter of any one or more of Examples 1-3 optionally include wherein the machine is a surface cleaning machine, and the functional modes include at least two of: sweeping, scrubbing, recovering, idling and transporting.

In Example 5, the subject matter of any one or more of Examples 1-4 optionally include a second sub-system, and wherein the power module monitors the load across the first and second sub-systems without individual current sensors operably coupled to each of the first and second sub-systems.

In Example 6, the subject matter of any one or more of Examples 1-5 optionally include wherein the first sub-system is a steering module and the second sub-system is a drive module.

In Example 7, the subject matter of any one or more of Examples 1-6 optionally include wherein the monitored load is a measured current level.

In Example 8, the subject matter of any one or more of Examples 1-7 optionally include wherein the sub-system includes a first set of motors that are operably coupled to the power module, wherein power provided to the first set of motors is adjustable by pulse width modulation (PWM), wherein the power module monitors a load on at least some of the motors of the first set of motors, and communicates the load to the MMC, and when the MMC determines that the load on one of the monitored motors has transgressed a load threshold, the PWM is adjusted to reduce an output of the motor that transgressed the load threshold.

In Example 9, the subject matter of Example 8 optionally includes a second power module operably coupled to the MMC by a second CAN bus, the second power module operably coupled to a second set of motors, wherein power to the second set of motors is adjustable by pulse width modulation (PWM), and wherein the second power module monitors a load on at least one of the motors of the second set of motors, and communicates the load to the MMC, and when the MMC determines that the load on one of the monitored motors has transgressed a second threshold, the PWM is adjusted to reduce an output of that motor.

In Example 10, the subject matter of any one or more of Examples 1-9 optionally include wherein the machine is selectively operable in a plurality of functional modes, and wherein the MMC automatically adjusts an engine speed based on the sub-system load information and the selected functional mode of the machine.

Example 11 is a method for controlling a motive machine having a main machine controller (MMC) operably coupled to a power module by a CAN bus, the method comprising: receiving at the MMC, from the power module, load information corresponding to a load of a sub-system operably coupled to the power module, wherein the load information includes a current load on a motor; determining, with the MMC that the current load has transgressed a threshold; and sending an instruction from the MMC, through the power module, to the sub-system to cause an action to reduce the load on the motor.

In Example 12, the subject matter of Example 11 optionally includes wherein the the motor includes scrub motor having a scrub element that is movable by an actuator, the method further comprising: monitoring, with the power module, a current load on the scrub motor; communicating, from the power module to the MMC, the current load on the scrub motor; and determining, with the MMC, if the current load has transgressed a threshold, and if the threshold has been transgressed, causing the actuator to be actuated to lift the scrub element to reduce the load on the motor by decreasing a force on the scrub element.

In Example 13, the subject matter of any one or more of Examples 11-12 optionally include wherein the motor includes one or more motors of a set of motors that are operably coupled to the power module, wherein the method further comprises: receiving an indication from the MMC, at the power module, to power one or more motors of a set of motors; providing power, with the power module, by pulse width modulation (PWM) to the one or more motors; monitoring, with the power module, a load on the one or more motors; determining, with the MMC using the monitored load from the power module, if any of the one or more motors has transgressed a load threshold; and when the load threshold has been transgressed by any of the one or more motors, adjusting, with the power module, the power provided to the one or more motors that transgressed the load threshold to reduce an output thereof.

In Example 14, the subject matter of Example 13 optionally includes the motive machine further including a second power module operably coupled to the MMC by a second CAN bus, the method further comprising: receiving an indication from the MMC, at a second power module, to power one or more motors of a second set of motors that are operably coupled to the second power module; providing power, with the second power module, by pulse width modulation (PWM) to the one or more motors of the second set of motors; monitoring, with the second power module, a load on the one or more motors of the second set of motors; determining, with the MMC using the monitored load from the second power module, if any of the one or more motors of the second set of motors has transgressed a second load threshold; and when the second load threshold has been transgressed by any of the one or more motors of the second set of motors, adjusting, with the second power module, the power provided to the motor that transgressed the second load threshold to reduce the output thereof.

In Example 15, the subject matter of any one or more of Examples 11-14 optionally include adjusting, using the MMC, an engine speed of the machine based on the sub-system load information and a selected functional mode of the machine.

Example 16 is at least one machine-readable medium including instructions for a main machine controller (MMC) to operate a control system for a motive machine, the motive machine having a power module and a sub-system operably coupled to the MMC by a CAN bus, and the instructions, when executed by a processor, cause the processor to: receive, at the MMC, from the power module via the CAN bus, load information corresponding to a load of the sub-system, wherein the sub-system includes a current load on a motor; determine, with the MMC, that the current load has transgressed a threshold; and send an instruction from the MMC, through the power module, to the sub-system to cause an action to reduce the load on the motor.

In Example 17, the subject matter of Example 16 optionally includes wherein the motor includes a scrub motor having a scrub element that is movable by an actuator, and the instructions, when executed by a processor, further cause the processor to: monitor, with the power module, a current load on the scrub motor; and communicate to the MMC the current load; and wherein to cause an action to reduce the load on the motor includes to cause the actuator to be actuated to lift the scrub element to reduce the load on the motor by decreasing a force on the scrub element.

In Example 18, the subject matter of any one or more of Examples 16-17 optionally include wherein the motor is one or more motors of a first set of motors that are operably coupled to the power module, and the instructions, when executed by a processor, further cause the processor to: receive, from a user input, an indication to power at least one of the one or more motors of a first set of motors; provide power, with the power module, by pulse width modulation (PWM) to the one or more motors; monitor, with the power module, a load on the one or more motors; determine, with the power module, if any of the one or more motors transgressed a load threshold; and when the load threshold has been transgressed by any of the one or more motors, adjust, with the power module, the power provided to the motor that transgressed the load threshold to reduce an output thereof.

In Example 19, the subject matter of any one or more of Examples 16-18 optionally include the motive machine further having a second power module operably coupled to the MMC by a second CAN bus, the instructions, when executed by a processor, further cause the processor to: receive, from a user input, an indication to power one or more motors of a second set of motors that are operably coupled to the second power module; provide power, with the second power module, by pulse width modulation (PWM) to the one or more motors of the second set of motors; monitor, with the second power module, a load on one or more motors of the second set of motors; determine, with the second power module, if any of the one or more motors of the second set of motors has transgressed a second load threshold; and when the second load threshold has been transgressed by any of the one or more motors of the second set of motors, adjust, with the second power module, the power provided to the motor that transgressed the second load threshold to reduce an output thereof

In Example 20, the subject matter of any one or more of Examples 16-19 optionally include wherein the instructions, when executed by a processor, further cause the processor to perform at least two of: sweeping, scrubbing, recovering, idling and transporting, depending on a functional mode of the machine selected by a user.

What is claimed is:

1. A motive machine comprising:
an engine;
a main machine controller (MMC) operably coupled to the engine;
a power module operably coupled to the MMC; and
a sub-system including a motor, wherein the motor is operably coupled to the power module by the CAN bus,
wherein the power module monitors a load of the sub-system, and using the monitored load of the sub-system, the power module communicates sub-system load information to the MMC,
wherein if the MMC determines that the current load on the motor has transgressed a threshold, the MMC, through the power module, takes an action to reduce the load on the motor.

2. The machine of claim 1, wherein the motor is a scrub motor having a scrub element that is movable by an actuator, and if the MMC determines that the current load on the scrub motor has transgressed the threshold, the MMC, through the power module, actuates the actuator to lift the scrub element to reduce the load on the scrub motor.

3. The machine of claim 1, wherein the sub-system includes a plurality of individual scrub motors that are operably coupled to the power module, and one or more of the individual scrub motors has a scrub element that is movable by an actuator, and wherein the power module monitors a current load on the individual scrub motors and communicates the current load to the MMC, and if the MMC determines that the current load on one of the individual scrub motors that has an actuator has transgressed a threshold, the MMC, through power module, actuates the actuator for that scrub element to lift the scrub element to reduce the load on the scrub motor.

4. The machine of claim 1, wherein the machine is a surface cleaning machine, and the functional modes include at least two of: sweeping, scrubbing, recovering, idling and transporting.

5. The machine of claim 1, further comprising a second sub-system, and wherein the power module monitors the load across the first and second sub-systems without individual current sensors operably coupled to each of the first and second sub-systems.

6. The machine of claim 1, wherein the first sub-system is a steering module and the second sub-system is a drive module.

7. The machine of claim 1, wherein the monitored load is a measured current level.

8. The machine of claim 1, wherein the sub-system includes a first set of motors that are operably coupled to the power module, wherein power provided to the first set of motors is adjustable by pulse width modulation (PWM), wherein the power module monitors a load on at least some of the motors of the first set of motors, and communicates the load to the MMC, and when the MMC determines that the load on one of the monitored motors has transgressed a load threshold, the PWM is adjusted to reduce an output of the motor that transgressed the load threshold.

9. The machine of claim 8, further comprising a second power module operably coupled to the MMC by a second CAN bus, the second power module operably coupled to a second set of motors, wherein power to the second set of motors is adjustable by pulse width modulation (PWM), and wherein the second power module monitors a load on at least one of the motors of the second set of motors, and communicates the load to the MMC, and when the MMC determines that the load on one of the monitored motors has transgressed a second threshold, the PWM is adjusted to reduce an output of that motor.

10. The machine of claim 1, wherein the machine is selectively operable in a plurality of functional modes, and wherein the MMC automatically adjusts an engine speed based on the sub-system load information and the selected functional mode of the machine.

11. A method for controlling a motive machine having a main machine controller (MMC) operably coupled to a power module by a CAN bus, the method comprising:
receiving at the MMC, from the power module, load information corresponding to a load of a sub-system operably coupled to the power module, wherein the load information includes a current load on a motor;
determining, with the MMC that the current load has transgressed a threshold; and
sending an instruction from the MMC, through the power module, to the sub-system to cause an action to reduce the load on the motor.

12. The method of claim 11, wherein the the motor includes scrub motor having a scrub element that is movable by an actuator, the method further comprising:
monitoring, with the power module, a current load on the scrub motor;
communicating, from the power module to the MMC, the current load on the scrub motor; and
determining, with the MMC, if the current load has transgressed a threshold, and if the threshold has been transgressed, causing the actuator to be actuated to lift the scrub element to reduce the load on the motor by decreasing a force on the scrub element.

13. The method of claim 11, wherein the motor includes one or more motors of a set of motors that are operably coupled to the power module, wherein the method further comprises:
receiving an indication from the MMC, at the power module, to power one or more motors of a set of motors;
providing power, with the power module, by pulse width modulation (PWM) to the one or more motors;
monitoring, with the power module, a load on the one or more motors;
determining, with the MMC using the monitored load from the power module, if any of the one or more motors has transgressed a load threshold; and
when the load threshold has been transgressed by any of the one or more motors, adjusting, with the power module, the power provided to the one or more motors that transgressed the load threshold to reduce an output thereof.

14. The method of claim 13, the motive machine further including a second power module operably coupled to the MMC by a second CAN bus, the method further comprising:
receiving an indication from the MMC, at a second power module, to power one or more motors of a second set of motors that are operably coupled to the second power module;
providing power, with the second power module, by pulse width modulation (PWM) to the one or more motors of the second set of motors;
monitoring, with the second power module, a load on the one or more motors of the second set of motors;
determining, with the MMC using the monitored load from the second power module, if any of the one or more motors of the second set of motors has transgressed a second load threshold; and
when the second load threshold has been transgressed by any of the one or more motors of the second set of motors, adjusting, with the second power module, the power provided to the motor that transgressed the second load threshold to reduce the output thereof.

15. The method of claim 11, further comprising:
adjusting, using the MMC, an engine speed of the machine based on the sub-system load information and a selected functional mode of the machine.

16. At least one machine-readable medium including instructions for a main machine controller (MMC) to operate a control system for a motive machine, the motive machine having a power module and a sub-system operably coupled to the MMC by a CAN bus, and the instructions, when executed by a processor, cause the processor to:
receive, at the MMC, from the power module via the CAN bus, load information corresponding to a load of the sub-system, wherein the sub-system includes a current load on a motor;
determine, with the MMC, that the current load has transgressed a threshold; and
send an instruction from the MMC, through the power module, to the sub-system to cause an action to reduce the load on the motor.

17. The at least one machine-readable medium of claim 16, wherein the motor includes a scrub motor having a scrub element that is movable by an actuator, and the instructions, when executed by a processor, further cause the processor to:
monitor, with the power module, a current load on the scrub motor; and communicate to the MMC the current load; and
wherein to cause an action to reduce the load on the motor includes to cause the actuator to be actuated to lift the scrub element to reduce the load on the motor by decreasing a force on the scrub element.

18. The at least one machine-readable medium of claim 16, wherein the motor is one or more motors of a first set of motors that are operably coupled to the power module, and the instructions, when executed by a processor, further cause the processor to:
receive, from a user input, an indication to power at least one of the one or more motors of a first set of motors;
provide power, with the power module, by pulse width modulation (PWM) to the one or more motors;
monitor, with the power module, a load on the one or more motors;
determine, with the power module, if any of the one or more motors transgressed a load threshold; and
when the load threshold has been transgressed by any of the one or more motors, adjust, with the power module, the power provided to the motor that transgressed the load threshold to reduce an output thereof.

19. The at least one machine-readable medium of claim 16, the motive machine further having a second power module operably coupled to the MMC by a second CAN bus, the instructions, when executed by a processor, further cause the processor to:
receive, from a user input, an indication to power one or more motors of a second set of motors that are operably coupled to the second power module;
provide power, with the second power module, by pulse width modulation (PWM) to the one or more motors of the second set of motors;
monitor, with the second power module, a load on one or more motors of the second set of motors;
determine, with the second power module, if any of the one or more motors of the second set of motors has transgressed a second load threshold; and
when the second load threshold has been transgressed by any of the one or more motors of the second set of motors, adjust, with the second power module, the power provided to the motor that transgressed the second load threshold to reduce an output thereof.

20. The at least one machine-readable medium of claim 16, wherein the instructions, when executed by a processor, further cause the processor to perform at least two of: sweeping, scrubbing, recovering, idling and transporting, depending on a functional mode of the machine selected by a user.
